(19) United States
(12) Patent Application Publication
(10) Pub. No.: US 2026/0001098 A1
(43) Pub. Date: Jan. 1, 2026

(54) SYSTEM AND METHOD FOR RESEALING SEALANT CONTAINERS

(71) Applicant: Sashco, Inc., Thornton, CO (US)

(72) Inventor: Les Burch, Thornton, CO (US)

(21) Appl. No.: 18/759,575

(22) Filed: Jun. 28, 2024

(51) Int. Cl. B05C 17/005

(52) U.S. Cl. CPC B05C 17/0052; B05C 17/00516

(57) ABSTRACT

A container system includes a container body having a dispensing end with an open nub. An elongated nozzle is removably coupled at a securement end portion with the open nub. A first end portion of a container plug is removably coupled with the open nub of the container body. A second end portion of the container plug is disposed within an interior of the nozzle, such that the container plug is at least partially encapsulated by the interior of the nozzle and an interior of the open nub. The second end portion of the container plug is shaped to be removably disposed within a dispensing opening of the nozzle to seal an interior of the nozzle. The second end portion of the container plug is further shaped to pass through the open nub of the container body and pierce a seal coupled with the dispensing end of the container body.

### BACKGROUND

Contractors and homeowners frequently use sealants, such as caulk, for a variety of projects. Oftentimes, a user will only dispense a partial amount of the sealant from within a container, such as a caulking cartridge. In these situations, it is desirable to be able to reseal the container to preserve the remaining sealant for later use.

Previous container plugs have been provided that attempt the task of resealing sealant containers. However, most container plugs are sold separately from sealant containers and the end user has limited exposure to these separate devices at the point of sale. Moreover, the container plugs are unavailable in many retail and contractor locations, leaving most end-users unaware that they exist.

A few configurations affix caps to the sealant containers by adding the cap as an appendage to the container. The challenge is that both a traditional dispensing nozzle and a cap must be supplied in such situations. Accordingly, various configurations couple a cap to one end of an elongated hang-tab, having a circular loop at an opposite end. The circular loop is disposed over a threaded nub of the sealant container. The dispensing nozzle is then screwed on over the threaded nub, securing the circular loop of the hang tab onto the nub. However, this configuration increases manufacturing costs and depresses sales. Any added components to the sealant container require an added step in the sealant container filling and packaging process, slowing it down and necessitating capital investment. Moreover, loosely attaching a cap to the exterior of the sealant container complicates the process of loading cartridges into shipping boxes, which requires machinery and box modifications. If all products are not changed to this new configuration, production lines must change constantly between the traditional cartridge (with only an affixed nozzle) and one with an added cap. Once delivered to the point of sale, buyers find the look of an extra device strapped to the sealant container to be odd. This confuses the buyers, causing most to bypass the odd-looking sealant container select one of the familiar looking sealant containers.

What is needed is a container plug that does not require any change in the cartridge configuration so that there is no difference in handling the cartridge for filling and packaging. Moreover, any new configuration shouldn't change in the ‘look and feel’ to the buyer.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure provides container system, having a container body with a dispensing end and an open nub. A nozzle, having a dispensing end and a securement end, is removably coupled with the open nub. A container plug, having opposite first and second end portions, is removably coupled at its first end portion with the open nub of the container body. The second end portion of the container plug is disposed within an interior of the nozzle, such that the container plug is at least partially encapsulated by the interior of the nozzle and an interior of the open nub.

In some embodiments, the first end portion of the container plug is shaped to be press-fit with the open nub. In at least one such embodiment, the first end portion of the container plug has a frustoconical shape. In other embodiments, a seal disposed within an interior of the container body, against a forward wall of the container body. The second end portion of the container plug may be shaped so as to come to a point that may be selectively passed through the open nub and pierce the seal. In other embodiments, the second end portion of the container plug is shaped so as to be selectively passed through, and removably engage, a dispensing opening formed in the nozzle and seal an interior of the nozzle.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a partial, exploded view of the sealant container plug of the present technology.

FIG. 2 depicts a partial, perspective view of the sealant container plug of FIG. 1 and one manner in which it can be assembled.

FIG. 3 depicts a partial, perspective view of the sealant container plug of FIG. 1 and one manner in which the plug can be disposed within a sealant container opening.

FIG. 4 depicts a partial, perspective view of the sealant container plug of FIG. 1 and one manner in which the plug can be disposed within a sealant container opening to pierce a container seal.

FIG. 5 depicts a partial, perspective view of the sealant container plug of FIG. 1 and one manner in which the plug can be disposed within a sealant container nozzle.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

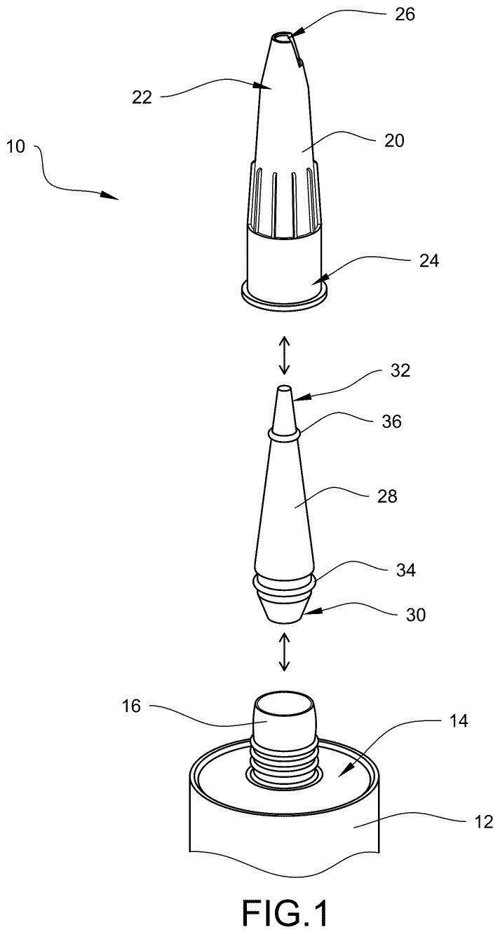

With reference to FIGS. 1-5, a container system 10 is disclosed for use with dispensable materials, such as sealants. As such, the container system 10 will include a container body 12, having a dispensing end 14. In some embodiments, the sealant is caulk. However, other sealants and dispensable materials are contemplated. In such exemplary embodiments, the container body 12 may be provided as a caulking cartridge. In various embodiments, the dispensing end 14 includes an open nub 16 that is in open, fluid communication with an interior portion of the container body 12. In some embodiments, a seal 18 is disposed within the interior of the container body 12, against a forward wall of the container body 12, at its dispensing end.

A nozzle 20, having a dispensing end 22 and a securement end 24 is provided for dispensing the contents of the container body 12. As such, the securement end 24 of the nozzle 20 is shaped to removably engage the open nub 16 and place the interior of the container body 12 in open, fluid communication with an interior of the nozzle 20. In at least some embodiments, mating threads on the securement end 24 of the nozzle 20 are used to removably couple with mating threads on the open nub 16. It is contemplated that the dispensing end 22 of the nozzle 20 may be initially provided to be closed. In such embodiments, an end user my cut or otherwise open the dispensing end 22 to provide a dispensing opening 26.

A container plug 28 is provided, having opposite first end portion 30 and second end portion 32. In various embodiments, the container plug 28 is formed from nylon or other barrier plastics, rubber, or cork, so that the container plug 28 may be used with water-based, solvent-based, and reactive sealants. The first end portion 30 is shaped to engage an interior wall of the open nub 16 in a manner that closes the open nub 16 and seals the interior of the open nub 16 and container body 12. In particular embodiments, the first end portion 30 of the container plug 28 has a frustoconical shape that facilitates the case in which the first end portion 30 is disposed within, and removed from, the open nub 16. It is contemplated that the first end portion 30 of the container plug 28 is shaped to be press-fit or friction-fit within the open nub 16. To further assist in securing the first end portion 30 with the open nub 16, it is further contemplated that one or more concentric rings 34 of small relief may be disposed around the circumference of the first end portion 30. Such concentric rings 34 can enhance the friction-fit between the opposing structures and increase the resistance to withdrawing the container plug 28 from within the open nub 16. In some embodiments, the first end portion 30 of the container plug 28 is provided with a length that is less than a height of the open nub 16. In such embodiments, the first end portion of the container plug will not extend through the open nub 16 and into the interior of the container body 12, preventing the unintentional piercing or displacement of the seal 18.

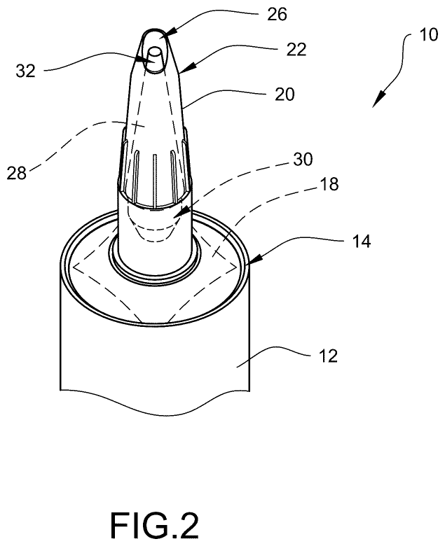

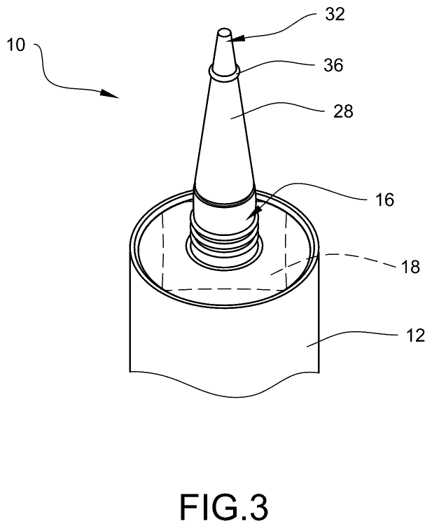

The second end portion 32 of the container plug 28 is shaped to be disposed within the interior of the nozzle 20. In various embodiments, the second end portion 32 of the container plug 28 approximates a shape of the interior portion of the nozzle 20. In some embodiments, the second end portion 32 of the container plug 28 is conically shaped. With reference to FIG. 2, the container system 10 may be disposed in an assembled position, such as when the container system is shipped or displayed at a point of sale. In such a position, the first end portion 30 of the container plug 28 is disposed within the open nub 16, such as depicted in FIG. 3, and the second end portion 32 of the container plug 28 is disposed within the interior of the nozzle 20. In this manner, the container plug 28 is at least partially encapsulated by the interior of the nozzle 20 and the interior of the open nub 16 and, in some embodiments, the interior of container body 12.

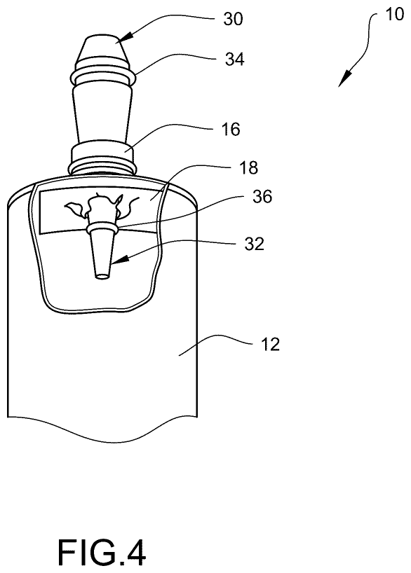

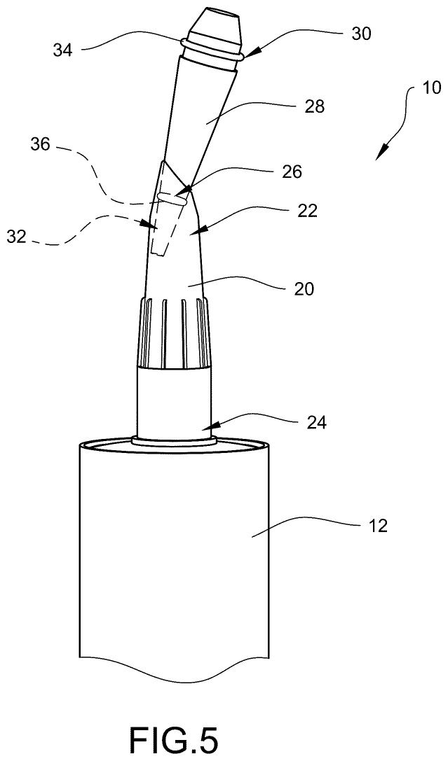

With further reference to FIG. 3, in at least one embodiment, the second end portion 32 of the container plug 28 is conically shaped, such that the second end portion 32 comes to a point. In at least one embodiment, such as depicted in FIG. 4, the second end portion 32 of the container plug is shaped to be disposed within the open nub 16 a sufficient distance that the point of the second end portion 32 of the container plug 28 pierces the seal 18. With reference to FIG. 5, the generally conical shape of the second end portion 32 of the container plug 28 can be of further benefit in sealing the dispensing opening 26 of the nozzle 20. In such embodiments, the second end portion 32 of the container plug 28 is shaped to be disposed within the dispensing opening 26 of the nozzle 20 and seal the interior of the nozzle 20 when the nozzle 20 is coupled with the open nub 16 of the container body 12. It is contemplated that, in such embodiments, the second end portion 32 of the container plug 28 is shaped to be press-fit or friction-fit within the dispensing opening 26, whether the dispensing opening 26 is provided by the nozzle manufacturer or cut into the nozzle 20 by the end user. To further assist in securing the second end portion 32 with the dispensing opening 26 of the nozzle 20, it is further contemplated that concentric rings 36 of small relief may be disposed around the circumference of the second end portion 32. Such concentric rings 36 can enhance the friction-fit between the opposing structures and increase the resistance to withdrawing the container plug 28 from within the dispensing opening 26 of the nozzle 20.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A container system, comprising:
a container body having a dispensing end; the dispensing end having an open nub;
a nozzle having a dispensing end and a securement end; the securement end of the nozzle being shaped to removably engage the open nub and place an interior of the container body in open communication with an interior of the nozzle;
a container plug having opposite first and second end portions; the first end portion being shaped to engage an interior wall of the open nub in a manner that closes the open nub and seals the interior of the container body; the second end portion of the container plug being shaped to be disposed within the interior of the nozzle.

2. The container system of claim 1 wherein:
the first end portion of the container plug is disposed within the open nub; and the second end portion of the container plug is disposed within the interior of the nozzle, such that the container plug is encapsulated by the interior of the nozzle and the interior of the container body.

3. The container system of claim 2 wherein:
the securement end of the nozzle is removably coupled with the open nub.

4. The container system of claim 3 wherein:
mating threads on the securement end of the nozzle are removably coupled with mating threads on the open nub.

5. The container system of claim 1, further comprising:
a seal disposed within the interior of the container body, against a forward wall of the container body.

6. The container system of claim 5 wherein:
the second end portion of the container plug is shaped to be disposed within the open nub a sufficient distance that the point of the second end portion of the container plug pierces the seal.

7. The container system of claim 6 wherein:
the first end portion of the container plug is shaped to have a length that is shorter than a height of the open nub so that, when the first end portion is disposed within the open nub, the first end portion of the container plug will not extend a sufficient distance to pierce the seal.

8. The container system of claim 7 wherein:
the first end portion of the container plug has a frustoconical shape and has a length that is shorter than a height of the open nub.

9. The container system of claim 1 wherein:
the first end portion of the container plug is shaped to be press-fit with the open nub.

10. The container system of claim 9 wherein:
the first end portion of the container plug has a frustoconical shape and has a length that is shorter than a height of the open nub.

11. The container system of claim 1 wherein:
the dispensing end of the nozzle is open; and
the second end of the container plug is shaped to be disposed within the opening of the nozzle and seal the interior of the nozzle when the nozzle is coupled with the open nub of the container body.

12. A container plug for use a container having a container body with a dispensing end, an open nub, and a removable nozzle, the container plug comprising:
a container plug body having opposite first and second end portions; the first end portion being shaped to engage an interior wall of the open nub in a manner that closes the open nub and seals an interior of the container body; the second end portion of the container plug being conically shaped.

13. The container plug of claim 12 wherein:
the second end portion of the container plug body is shaped to approximate an interior of the nozzle, whereby the container body is encapsulated by the interior of the nozzle and an interior of the container body nub when the nozzle is coupled with the open nub.

14. The container plug of claim 12 wherein:
the second end portion of the container plug body is shaped to pass through the open nub of the container body and pierce a foil seal disposed in the container body.

15. The container plug of claim 12 wherein:
the second end portion of the container plug body is shaped to pass through an opening in a dispensing end of the nozzle and seal an interior of the nozzle when the nozzle is coupled with the open nub of the container body.

16. The container plug of claim 12 wherein:
the first end portion of the container plug body is shaped to be press-fit with the open nub.

17. The container plug of claim 16 wherein:
the first end portion of the container plug body has a frustoconical shape; and
the first end portion of the container plug body is shaped to have a length that is shorter than a height of the open nub so that, when the first end portion is disposed within the open nub, the first end portion of the container plug body will not extend a sufficient distance to pierce a seal disposed in the container body.

18. A container system, comprising:
a container body having a dispensing end; the dispensing end having an open nub;
a nozzle having a dispensing end and a securement end; the securement end of the nozzle being removably coupled with the open nub;
a container plug having opposite first and second end portions; the first end portion being removably coupled with the open nub of the container body; the second end portion of the container plug being disposed within an interior of the nozzle, such that the container plug is at least partially encapsulated by the interior of the nozzle and an interior of the open nub.

19. The container system of claim 18, further comprising:
a seal disposed within an interior of the container body, against a forward wall of the container body; and
the second end portion of the container plug is shaped so as to come to a point that may be selectively passed through the open nub and pierce the seal.

20. The container system of claim 18, further comprising:
a dispensing opening formed in the dispensing end of the nozzle; and
the second end portion of the container plug is shaped so as to be selectively passed through, and removably engage, the dispensing opening and seal an interior of the nozzle.

21. The container system of claim 18 wherein:
the first end portion of the container plug is shaped to be press-fit with the open nub; and
the first end portion of the container plug is shaped to have a length that is shorter than a height of the open nub so that, when the first end portion is disposed within the open nub, the first end portion of the container plug will not extend a sufficient distance to pierce a seal disposed in the container body.
